(19) United States
(12) Patent Application Publication
(10) Pub. No.: US 2013/0068043 A1
(43) Pub. Date: Mar. 21, 2013

(54) APPARATUS AND METHODS FOR PREPARATION AND ANALYSIS OF DRIED SAMPLES OF A BIOLOGICAL FLUID

(71) Applicants: Moon Chul Jung, Arlington, MA (US); Edouard S. P. Bouvier, Stow, MA (US); Geoff C. Gerhardt, Milbury, MA (US)

(72) Inventors: Moon Chul Jung, Arlington, MA (US); Edouard S. P. Bouvier, Stow, MA (US); Geoff C. Gerhardt, Milbury, MA (US)

(73) Assignee: WATERS TECHNOLOGIES CORPORATION, Milford, MA (US)

(21) Appl. No.: 13/698,164

(22) PCT Filed: May 31, 2011
(86) PCT No.: PCT/US11/38494

§ 371 Date: Nov. 15, 2012

Related U.S. Application Data
(60) Provisional application No. 61/350,175, filed on Jun. 1, 2010.

(51) Int. Cl. B01L 3/00

(52) U.S. Cl. 73/864.91

(57) ABSTRACT

Described is a device for collecting a fluid sample, such as a biological fluid sample. The device includes a planar collection substrate having an absorbent material. The planar collection substrate includes an impermeable region and a sample collection region. The impermeable region is impermeable to the fluid sample and is embedded in the planar collection substrate in a spatial pattern. The sample collection region is in an area excluded from the spatial pattern and has a shape and a size defined by the spatial pattern. The sample collection region is configured to receive a known volume of the fluid sample. In an alternative form, the device includes a sample collection element disposed in an impermeable planar holder and, in another alternative form, the device includes an absorbent material disposed inside an impermeable tube wall.

### RELATED APPLICATION

This application claims the benefit of the earlier filing date of U.S. Provisional Patent Application Ser. No. 61/350,176, filed Jun. 1, 2010 and titled “Apparatus and Methods for Preparation and Analysis of Dried Small-Volume Samples of a Biological Fluid,” the entirety of which is incorporated herein by reference.

### FIELD OF THE INVENTION

The invention relates generally to chromatographic analyses of dried biological fluids. More particularly, the invention relates to the preparation of dried biological fluids, such as dried blood spots, on collection media and the extraction of previously dried samples.

### BACKGROUND

Measuring concentrations of administered drugs and their metabolites in biological fluids, such as whole blood, plasma and serum, is important to understanding the efficacy and toxicological effects of the drugs. Typical clinical studies require handling and processing large numbers of biological fluid samples at low temperature with special care. Dried spot sampling is an alternative to the current practice and is based on collection of small volumes (e.g., several microliters or less) of biological fluids as dried spots. For example, dried blood spot (DBS) sampling involves the collection of small volumes of blood onto a carrier medium. Samples are later reconstituted from the dried spots using suitable solvents during an extraction process. The reconstituted samples can be analyzed, for example, in a liquid chromatography—mass spectrometry (LC-MS) assay. In many instances, this technique fails to deliver a desirable detection sensitivity and ease of use.

### SUMMARY

In one aspect, the invention features a device for collecting a fluid sample, such as a biological fluid sample. The device includes a planar collection substrate having an absorbent material. The planar collection substrate includes an impermeable region and a sample collection region. The impermeable region is embedded in the planar collection substrate in a spatial pattern and is impermeable to a fluid sample. The sample collection region is in the planar collection substrate in an area excluded from the spatial pattern of the impermeable region. The sample collection region has a shape and a size defined by the spatial pattern and is configured to receive a known volume of the fluid sample based on the size.

In another aspect, the invention features a device for collecting a fluid sample, such as a biological fluid sample, that includes a planar holder comprising a material impermeable to a fluid sample. The device further includes a sample collection element disposed in the planar holder. The sample collection element includes an absorbent material and has a shape configured to receive a known volume of the fluid sample.

In still another aspect, the invention features a device for collecting a fluid sample, such as a biological fluid sample, that includes a tube wall and an absorbent material disposed inside the tube wall. The tube wall is impermeable to a fluid sample. The absorbent material is configured to receive a known volume of the fluid sample applied at an end of the tube wall based on a size of the absorbent material.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A is a cross-sectional illustration of a conventional flow-through extraction module and a conventional dried sample carrier.

FIG. 1B is a cross-sectional view showing how the flow-through extraction module of FIG. 1A can be used to extract a sample from an embodiment of a planar collection device according to the invention.

FIG. 1C is a perspective view showing an alternative flow-through extraction module that can be used to extract a sample from an embodiment of a planar collection device according to the invention.

FIG. 2A is a cross-sectional view of a single-sided extraction module and a conventional dried sample carrier.

FIG. 2B illustrates the use of the single-sided extraction module of FIG. 2A with an embodiment of a planar collection device according to the invention.

FIG. 3 illustrates a planar collection device according to an embodiment of the invention.

FIG. 4 illustrates a planar collection device according to another embodiment of the invention.

FIG. 5 is a cross-sectional view of a planar collection device according to another embodiment of the invention.

FIG. 6 illustrates a planar collection device according to another embodiment of the invention.

FIG. 7 illustrates a collection device having a non-planar collection medium in the shape of a tube in accordance with another embodiment of the invention.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

Various DBS sampling techniques provide cost-saving benefits in clinical trials when compared to conventional plasma sampling methods. A common protocol for DBS sampling utilizes treated or untreated planar filter paper as the collection medium. A blood sample is drawn from an animal or a human subject. The sample can be drawn by a simple skin prick, or from venous sampling. Typically, a fixed volume of the blood sample is transferred to the planar filter paper using a glass capillary pipette and the resulting blood spot is dried for storage and transport. At an analytical facility, a small disc that includes at least a portion of the DBS is punched from the filter paper and immersed in an extraction solution to liberate compounds of interest. This reconstitution process of punching and extraction typically dilutes the sample by a factor of 150 or more.

In brief overview, the invention relates to collection devices for dried samples of a biological fluid and extraction methods used with the collection devices. By way of examples, biological fluid samples include blood samples, urine samples, saliva samples, plasma samples, serum samples and cerebrospinal fluid samples. The collection devices offer a number of benefits over conventional collection devices, including an improvement in the sample extraction efficiency achieved by extracting most of or the entire collected sample and utilizing less extraction solvent during the extraction process. Advantageously, the collection devices and extraction methods maintain the benefit of easy sample collection and the handling of dried samples. Optionally, extraction is achieved by direct manipulation of the collection medium using an extraction module. The extraction process can be incorporated in an on-line process in advance of a sample injector or can be adapted for batch processing with automated fluidic controls.

In various embodiments, the collection device includes a collection medium having collection regions into which biological fluids are deposited. Each collection region has a shape and size defined, at least in part, by an impermeable pattern so that each collection region accommodates a known volume of a fluid sample. The impermeable pattern optionally assists a seal, such as a knife seal, on an extraction head so that the extraction volume is completely confined. In some embodiments, the collection regions are chemically modified to offer optimized surface characteristics, or to imbed chemicals for internal standards or in-spot chemical reactions.

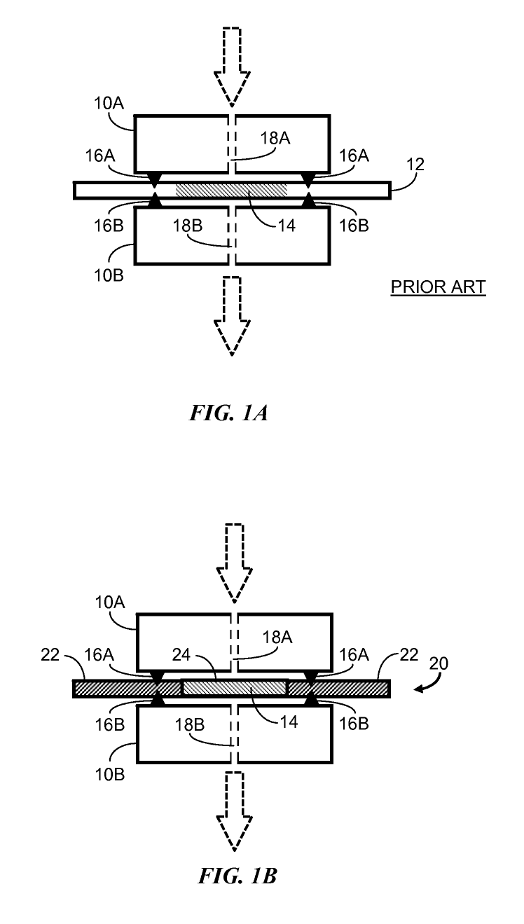

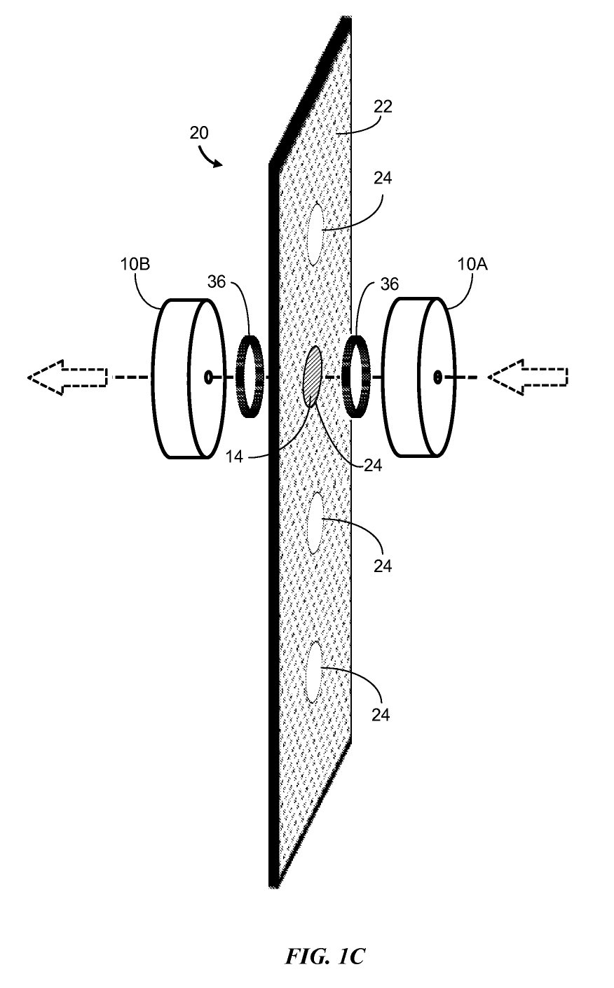

Referring to FIG. 1A, a conventional sandwich-type extraction module 10 is shown in a cross-sectional view. The module 10 includes two heads 10A and 10B arranged on opposite sides of a dried sample carrier 12, for example, a DBS card comprising absorbent paper. A dried sample spot 14 on the sample carrier 12 is surrounded by a protrusion 16A, 16B (generally 16) on each head 10. A fluid sample is reconstituted by passing an extraction fluid or solvent in the direction of the dashed arrows through the dried sample spot 14. In particular, an extraction solvent supplied through a fluid conduit 18A in the inlet head 10A passes through the carrier 12 in an area that includes the sample spot 14 and exits through a fluid conduit 18B in the outlet head 10B. A gap exists between the opposing protrusions 16. Due to the intrinsic porosity of the sample carrier material and the incomplete seal achieved by the protrusions 16, the volume of extraction fluid in the extraction sample and the region of the sample carrier receiving the extraction fluid are not well controlled.

FIG. 1B is a cross-sectional view showing how the flow-through extraction module 10 can be used to extract a sample from an embodiment of a planar collection device 20 according to the invention. The device 20 includes a planar collection substrate comprising an absorbent material. The collection substrate includes an impermeable region 22 spatially defined by a pattern and sample collection regions 24 (only one visible) in which biological fluid samples are applied. The impermeable region 22 is a region of the substrate in which fluid cannot enter or pass through. Thus the biological fluid sample at the time of application is laterally confined according to the shape of the respective sample collection region 24. During the extraction process, a complete seal is achieved by penetration of the protrusions 16 into the impermeable region 22. Thus the extraction solvent is prevented from wetting the device 20 in the impermeable region 22 and is restricted from lateral flow by the knife edge seal. A significant advantage is that the dimensions of the sample collection regions 24 can be accurately controlled through accurate definition of the pattern, leading to better control and knowledge of the volumes of the applied fluid samples accepted by the sample collection regions 24.

FIG. 1C is a perspective view showing another extraction module that can be used to extract a sample from the planar collection device 20. A complete seal is achieved when the device 20 and seals 36 are sandwiched between the two heads 10A and 10B so that the seals 36 are pressed against the impermeable region 22 surrounding the appropriate sample collection region 24. Seal mechanisms can include the illustrated annular-shaped seals 36 and other forms of seals that can be compressible. Alternatively, the seal mechanisms may be rigid and can provide a seal when penetrating into the impermeable region 22. Seals can have a flat face or a sharp edge to penetrate into the impermeable region 22.

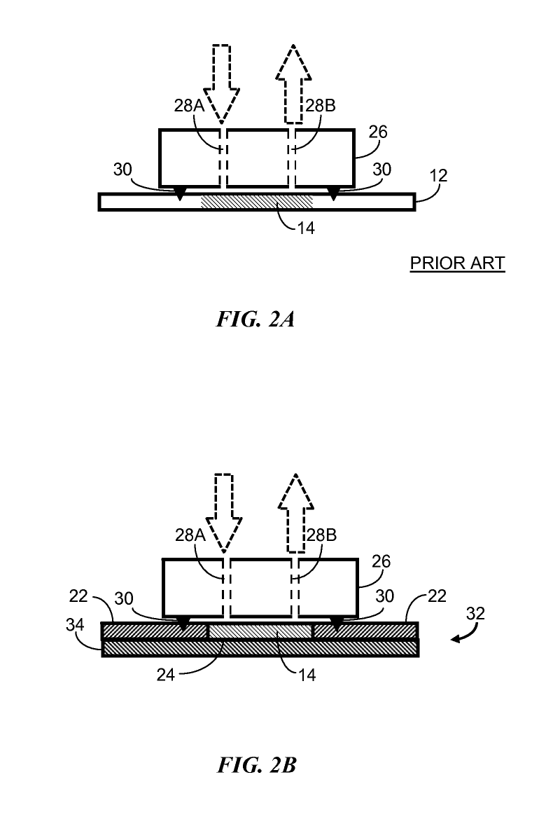

FIG. 2A is a cross-sectional view of a single-sided extraction module. The module includes a single head 26 having an inlet fluid conduit 28A to supply the extraction solvent to the dried sample spot 14 on a sample carrier 12 and an outlet fluid conduit 28B for the reconstituted fluid sample to exit the head 26. As described above with respect to FIG. 1A, the knife edge seal is incomplete and extraction solvent can leak laterally into the carrier medium outside the region defined by the knife edge protrusions 30.

FIG. 2B illustrates the use of the single-sided extraction module of FIG. 2A with an embodiment of a planar collection device 32. The collection device 32 is similar to the device 20 shown in FIG. 1B; however, the illustrated device 32 further includes an impermeable layer 34 on the backside of the planar collection substrate. For example, the impermeable layer 34 can be an impermeable tape applied to the backside of the planar collection substrate.

To reconstitute a fluid sample, the head 26 is applied to the side of the device 32 that allows access to the sample collection region 24 that contains the dried sample spot 14. A seal is formed between the knife edge protrusion 30 and the nearby portion of the impermeable region 22 that surrounds the sample collection region 24. Extraction solvent flowing from the inlet fluid conduit 28A wets the sample collection region 24 while being confined laterally by the knife edge seal or by the impermeable region 22 if the head 26 is pressed against the impermeable region 22. The impermeable layer 34 prevents extraction solvent from exiting the backside of the device. The reconstituted fluid sample exits the head 26 through the outlet fluid conduit 28B and can be provided to analytical equipment for analysis.

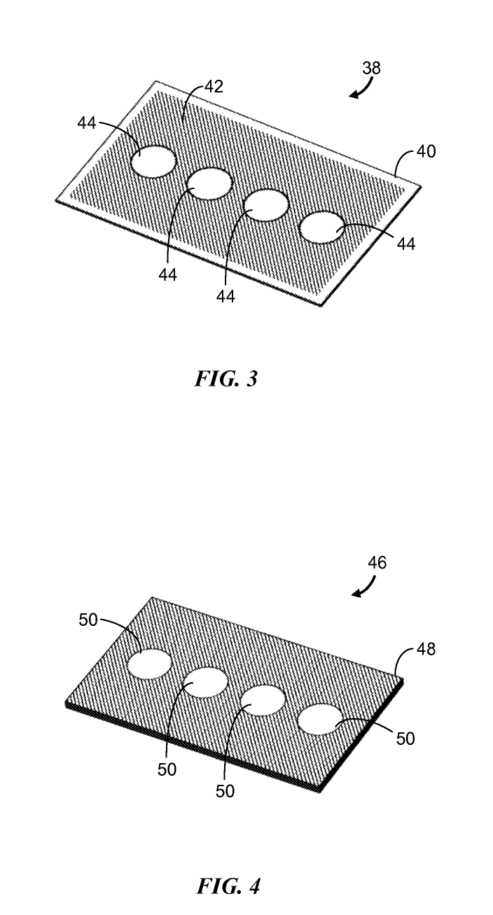

FIG. 3 illustrates an embodiment of a planar collection device 38. The device 38 includes a collection substrate 40 comprising filter paper or other material capable of absorbing a biological fluid. A pattern 42 is printed into the collection substrate 40 using an ink or other printable substance. As illustrated, the pattern 42 has a rectangular shape with four circular openings. The ink fills pores in the filter paper and prevents fluids from being absorbed in the impermeable patterned region 42. By way of examples, the ink or printable substance can be a wax, a photoresist, a sol-gel precursor or a polymer precursor. The degree to which the impermeable region 22 is impermeable to an applied fluid can be defined in terms of a contact angle, that is, the angle at which a fluid interface meets the surface of the impermeable region 22. The contact angle generally exceeds 90° for most impermeable materials. In some embodiments, a hydrophobic ink is used to a pattern that is impermeable to aqueous biological fluids.

The portions of the collection substrate 40 that are not printed (i.e., the four circular openings in the pattern) are collection regions 44 for receiving biological fluid samples. To reconstitute and extract a biological fluid sample, an extraction head with a knife edge seal or similar sealing mechanism is pressed against the printed area 42 in a location that surrounds the respective collection region 44 for improved liquid containment within the extraction volume. Alternatively, a biological fluid sample is reconstituted and extracted by removing a portion of the device 38 that includes an entire collection region 44 and placing the removed portion in a container with an extraction solvent. The removed portion preferably includes some of the impermeable region 42 that surrounds the collection region 44 to ensure that the entire collection region 44 contributes to the reconstituted biological fluid sample. Any part of the impermeable region 42 that is removed with the collection region 44 does not adversely affect the ability to accurately reconstitute the biological fluid sample.

According to another embodiment of a planar collection device, a collection substrate is processed to form one or more impermeable regions and sample collection regions without the need to print with an impermeable ink or to apply a non-porous material to the substrate. In one such embodiment, the planar collection substrate is a porous thermoplastic material that is heated in one or more defined spatial regions. The heated regions are converted into non-porous and impermeable regions by deformation or melting. The impermeable regions may retain a minor porosity; however, the remaining porosity is insufficient to permit significant infiltration of a fluid sample. To extract a reconstituted biological fluid sample, an extraction module featuring a knife edge seal or similar sealing feature is pressed against the impermeable region surrounding a sample collection region for improved fluid containment.

FIG. 4 illustrates another embodiment of a planar collection device 46. The device 46 includes a planar holder 48 fabricated from a hard and non-porous material that is impermeable to an applied fluid. Sample collection elements 50 are fabricated from porous material. Each sample collection element 50 is disc-shaped and has a thickness that is less than or approximately equal to the thickness of the holder 48. In alternative embodiments, the sample collection elements 50 can have other shapes and may have thicknesses that exceed the thickness of the holder 48. The porous material may provide a desired surface activity. The sample collection elements 50 are optionally formed of porous material that is different from the porous material of one or more of the other sample collection elements 50. In some embodiments, two or more thin layers of porous material are stacked together for a sample collection element 50. The sample collection elements 50 may be provided in openings between the upper and lower parallel sides of the holder 48 so that extraction of biological fluid samples is achieved using a flow through technique such as that shown in FIG. 1B. In alternative embodiments, the holder 48 includes pockets in which the sample collection elements 50 reside so that extraction of biological fluid samples is achieved using a single-sided extraction technique such as that shown in FIG. 2B. Optionally, extraction seals can be provided on the holder 48 to function in a manner similar to that of the seals 36 in FIG. 1C. For example, an annular seal can be secured to the holder 48 to surround each sample collection element 50. The annular seal can be on a single side or on both sides of the holder 48, depending on the particular form of the holder 48 and the applicable extraction technique.

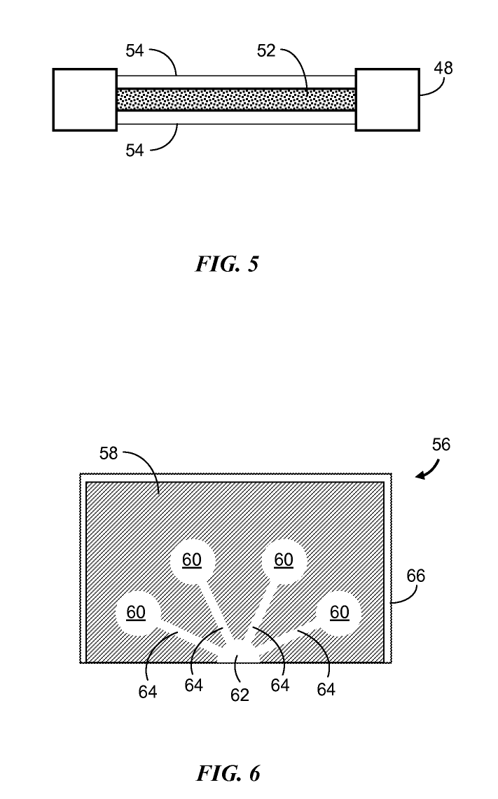

In alternative embodiments, sample collection elements are formed as packed particle structures. For example, silica, hybrid silica or polymer particles are packed into small discs that are secured in the holder. Optionally, various types of particles are packed together in a single disc to impart multiple functionalities. The particles can be glued together to form a single disc-shaped unit. Alternatively, the particles 52 can be sandwiched between retainers 54 as shown in a cross-sectional view in FIG. 5. Retainers, as used herein, are structures that are used to keep the particles 52 in a packed state. By way of an example, each retainer 54 can be a porous structure of sintered particles such as a frit. Alternatively, the retainers 54 can be formed from woven or non-woven fibers of various types of materials such as polymer, cellulose and metal.

According to certain embodiments, analytes of interest are not adsorbed by and do not interact with the surface of the particles. The particles can be porous or non-porous. If the particles are non-porous, they form a bed which comprises pores within the interstices of the particles. In this case, the absorbent consists of the interstitial space into which the sample solution can permeate. In other embodiments, the particles are porous, and sample absorbs both in the interstitial space and the pores of the individual particles. The wettability of both the particles and the surface within the pores is important. If the contact angle at the solid/air/liquid interface is less than 90°, the solid material is wetted and liquid inherently penetrates into the pores and interstices. The interstitial and intra-particle pore volumes are accurately defined by accurate control of the amount of particles and the packing density. One benefit is that excess liquid is readily removed by application of a pressure differential. Through constraint of pore size, large molecules such as proteins can be excluded, thus providing a crude separation and removal of such interferences. Collection devices fabricated in this manner yield a high degree of precision and accuracy in the amount of fluid that is contained.

For devices having sample collection elements based on the packed particle structure, the particle surfaces can interact with or adsorb either analytes of interest or key contaminants. For example, the particles provide sites for ion exchange, hydrophobic adsorption or other types of adsorption so that analytes can readily be separated from matrix interferences.

In other embodiments, a planar collection device according to the invention includes a paper-based substrate having an impermeable pattern configured to impart certain functionalities. In one such embodiment shown in FIG. 6, a planar collection device 56 has an impermeable pattern 58 that defines a number of sample collection regions 60 that function as storage wells, a sample inlet 62 to receive an applied biological fluid sample, and a number of fluidic paths 64 to guide the biological fluid sample to the sample collection regions 60. The impermeable pattern 58 is formed in the substrate 66 according to one of the previously-described techniques and is configured to precisely define the collection volumes, that is, the fluid volume capacities of the sample collection regions 60. In various other embodiments, patterns can include multiple inlet regions or fluidic paths that guide fluid samples to one or more lateral flow filters or other regions of the device.

The sample collection regions 60 absorb a portion of the fluid sample applied to the sample inlet site by capillary force. The liquid volume capacity is a function of several physical parameters, such as absorbent surface areas, pore diameters and liquid densities. The collection volumes of the sample collection regions 60 are determined by controllable parameters at the time of sample collection and not by environmental factors such as drying rates and the speed at which the fluid sample is applied to the device 56.

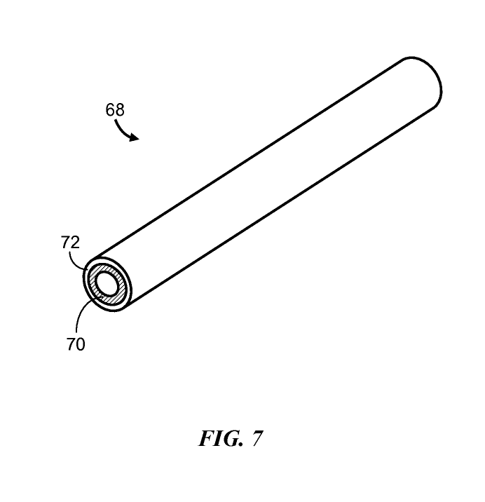

In other embodiments, collection devices are based on non-planar collection media. For example, FIG. 7 shows an embodiment of a collection device 68 where the non-planar collection medium has a tubular shape. The device 68 is in the shape of a tube and has an inner layer 70 of absorbent material disposed on the inner surface of an outer protective tube wall 72 that is impermeable to the fluid sample. Alternatively, the entire volume of the tube inside the protective layer 72 (i.e., the internal volume of the device 68) can be filled by the absorbent material. Fluid is drawn into the absorbent layer 70 by capillary force. The volume of fluid collected by the device 68 is dependent on the volume occupied by the solid component of the absorbent material, that is, the fluid occupies the pores and interstices of the absorbent material and can be accurately controlled. If a pressure (positive or negative) is applied, a portion of the fluid within the interstices flows out of the device 68. The amount of fluid that flows from the device 68 depends on several variables including, for example, packing density, applied pressure, contact angle and the viscosity of the fluid sample. The collected fluid volume may be modified by changing the dimensions or porosity of the absorbent material. Optionally, chemical reactions that provide specific functionalities are achieved using similar particle structures to those described above with respect to the device of FIG. 5.

One significant advantage of the tube-shaped collection device 68 over a planar collection device is the lack of a need for a separate extraction module. For example, the illustrated collection device 68 can be adapted for coupling to a fluidic path using conventional fittings, such as ferrule-nut assemblies.

In other embodiments, a tube-shaped collection device includes a bed of particles bound together, for example, by sintering or gluing. Alternatively, the tube-shaped collection device can contain a porous monolithic structure. As described above, if the bed of particles or monolithic structure includes pore volume, a pressure differential applied across the tube results in the capture of a specific volume of fluid.

In view of the above description, one of skill will understand that alternative device shapes and combinations of device components are within the scope of the invention. In one such embodiment, the collection and storage of replicate samples utilizes multiple tubes that are bundled together side-by-side, for example in a 12×8 arrangement (96-well) format, to be easily adapted to automated sample handling at the analysis stage. Alternatively, samples may be acquired using individual tubes and bundling occurs at the analysis site. In another embodiment, an extended tube is used to collect a fluid sample. The extended tube is scored or otherwise marked to enable easy separation of a known length and volume for subsequent analysis.

In various embodiments, including the embodiments illustrated in the figures and described above, the collection devices optionally further include sample-tracking features. For example, sample-tracking features include machine-readable optical codes such as bar codes, two-dimensional bar codes, matrix codes and the like, and electronic tracking components such as embedded or attached radio frequency identification (RFID) tags.

Various embodiments of the invention, such as the examples described above, can be implemented with any suitable analytical apparatus. For example, some embodiments entail modified liquid-chromatography and/or mass-spectrometry apparatus, such as an ACQUITY® or TRIZAIC® LC/MS system (available from Waters Corporation, Milford, Mass.)

In some embodiments, collection devices are provided as part of a kit that also includes drying units such as evacuable pouches. For example, after deposition of a fluid sample on a collection device, the collection device is placed in an evacuable pouch, the pouch is sealed, and air is removed from the pouch to promote drying of the sample. Air is removed, for example, through use of a syringe that communicates with an interior of the pouch.

While the invention has been shown and described with reference to specific embodiments, it should be understood by those skilled in the art that various changes in form and detail may be made therein without departing from the spirit and scope of the invention as recited in the accompanying claims.

What is claimed is:

1. A device for collecting a fluid sample, comprising:
a planar collection substrate having an absorbent material, the planar collection substrate comprising:
an impermeable region embedded in the planar collection substrate in a spatial pattern and being impermeable to a fluid sample; and
a sample collection region in the planar collection substrate in an area excluded from the spatial pattern of the impermeable region, the sample collection region having a shape and a size defined by the spatial pattern and being configured to receive a known volume of the fluid sample based on the size.

2. The device of claim 1 wherein the impermeable region of the planar collection substrate comprises a non-absorbing material applied to the planar collection substrate in the spatial pattern.

3. The device of claim 2 wherein the non-absorbing material comprises a material that is printed into the planar collection substrate.

4. The device of claim 2 wherein the non-absorbing material comprises one of a wax, a photoresist, a sol gel precursor and a polymer precursor.

5. The device of claim 1 wherein the fluid sample is a biological fluid sample.

6. The device of claim 5 wherein the biological fluid sample comprises one of a blood sample, a urine sample, a saliva sample, a plasma sample, a serum sample and a cerebrospinal fluid sample.

7. The device of claim 1 wherein the planar collection substrate has a first side to receive the fluid sample and a second side opposite the first side, the device further comprising an impermeable layer disposed adjacent to the second side of the planar collection substrate.

8. The device of claim 7 wherein the impermeable layer is a tape comprising an impermeable material.

9. The device of claim 1 wherein the planar collection substrate is a porous thermoplastic material and wherein the impermeable region is an area of the porous thermoplastic substrate that is heated to render the planar collection substrate non-porous in the spatial pattern.

10. The device of claim 1 wherein the planar collection substrate further comprises:
a sample inlet to receive a fluid sample; and
a fluidic path between the sample inlet and the sample collection region,
the sample inlet and the fluidic path being in an area excluded from the spatial pattern of the impermeable region, wherein the fluidic path guides the fluid sample from the sample inlet to the sample collection region.

11. The device of claim 1 wherein the planar collection substrate comprises an adsorbent material.

12. The device of claim 1 wherein the impermeable region has a contact angle of greater than 90° with respect to the fluid sample.

13. A device for collecting a fluid sample, comprising:
a planar holder comprising a material impermeable to a fluid sample; and
a sample collection element disposed in the planar holder and comprising an absorbent material, the sample collection element having a shape configured to receive a known volume of the fluid sample.

14. The device of claim 13 wherein the planar holder comprises a rigid material.

15. The device of claim 13 wherein the planar holder has a pair of parallel surfaces with an opening therebetween with a sample collection element disposed in the opening.

16. The device of claim 13 wherein the planar holder has a pocket with a sample collection element disposed therein.

17. The device of claim 13 wherein the sample collection element is a disc-shaped element.

18. The device of claim 13 wherein the fluid sample is a biological fluid sample.

19. The device of claim 18 wherein the biological fluid sample comprises one of a blood sample, a urine sample, a saliva sample, a plasma sample, a serum sample and a cerebrospinal fluid sample.

20. The device of claim 13 wherein a plurality of sample collection elements are disposed in the planar holder and wherein one of the sample collection elements comprises an absorbent material that is different than an absorbent material of another one of the sample collection elements.

21. The device of claim 13 wherein the absorbent material of the sample collection element comprises a plurality of absorbent layers.

22. The device of claim 13 further comprising an annular seal affixed to a surface of the planar holder about the sample collection element.

23. The device of claim 15 further comprising a first annular seal affixed to one of the parallel surfaces about the sample collection element and a second annular seal affixed to the other one of the parallel surfaces about the sample collection element.

24. The device of claim 13 wherein the sample collection element comprises a structure having particles packed into the shape of the sample collection element.

25. The device of claim 24 wherein the particles comprise one of silica particles, hybrid silica particles and polymer particles.

26. The device of claim 24 wherein the sample collection element further comprises a pair of retainers with the particles disposed between the retainers.

27. The device of claim 24 wherein the particles adsorb an analyte of interest.

28. The device of claim 24 wherein the particles adsorb a sample contaminant.

29. A device for collecting a fluid sample, comprising:
a tube wall that is impermeable to a fluid sample; and
an absorbent material disposed inside the tube wall and configured to receive a known volume of the fluid sample applied at an end of the tube wall based on a size of the absorbent material.

30. The device of claim 29 wherein the absorbent material is an absorbent layer disposed on an inner surface of the tube wall.

31. The device of claim 30 wherein the absorbent material comprises a plurality of absorbent layers disposed on the inner surface of the tube wall.

32. The device of claim 29 wherein the absorbent material entirely fills an internal volume of the tube wall.

33. The device of claim 29 wherein the fluid sample is a biological fluid sample.

34. The device of claim 33 wherein the biological fluid sample comprises one of a blood sample, a urine sample, a saliva sample, a plasma sample, a serum sample and a cerebrospinal fluid sample.

35. The device of claim 29 further comprising fluidic couplings secured to ends of the tube wall for coupling to a fluidic path.

36. The device of claim 29 wherein the absorbent material comprises bound particles.

37. The device of claim 29 wherein the tube wall and absorbent material are configured for separation of the device into a plurality of lengths having known sample collection volumes.

38. The device of claim 29 wherein the absorbent material disposed inside the tube wall is adsorbent for a constituent of the fluid sample.
